(19) United States
(12) Patent Application Publication
(10) Pub. No.: US 2011/0040770 A1
(43) Pub. Date: Feb. 17, 2011

(54) ROBUST XPATHS FOR WEB INFORMATION EXTRACTION

(75) Inventors: Amit MADAAN, Kanpur (IN); Charu TIWARI, Bhopal (IN); Rupesh R. MEHTA, Solapur (IN)

Correspondence Address: Evergreen Valley Law Group, P.C. and Yahoo! Inc., 4 North Second Street, Suite 598, San Jose, CA, 95113, US

(73) Assignee: Yahoo! Inc., Sunnyvale, CA (US)

(21) Appl. No.: 12/540,384

(22) Filed: Aug. 13, 2009

(51) Int. Cl. G06F 17/30

(52) U.S. Cl. 707/754; 707/E17.109

(57) ABSTRACT

An example of a method includes generating an attributed extensible markup language path (XPath) for an annotated entity in a web page. The method further includes determining a first node that satisfy the attributed XPath in the web page and is annotated. The method also includes identifying an attribute property that satisfies predefined criteria in the web page while traversing from the first node to a root node, the attribute property comprising an attribute value and an attribute name. Moreover, the method includes populating the attributed XPath with the attribute property that satisfies predefined criteria. The method also includes filtering the attributed XPath to generate a robust XPath, and extracting content from multiple web pages based on the robust XPath.

### BACKGROUND

Over a period of time, web content has increased many folds. The web content is present in various formats, for example hypertext mark-up language (HTML) format. Finding and locating desired content in a time efficient manner is still a challenge. Further, the desired content needs to be extracted with accuracy.

Currently, extensible markup language (XML) path (XPaths) is used for extracting the desired content. A web page can be represented in form of a tree. A node in a tree represents content. XPath is a query language used for selecting nodes from the tree. However, certain nodes having the desired content are missed as the web pages can have slight variations in structure, for example missing values or tags, making the XPath ineffective for such web pages. The XPaths have position criterion which limits the extraction to the web pages that absolutely match such XPaths. The situation worsens when changes in the content of the web page occur quite frequently. For example, products offered at discounted price on a web page may change between thanksgiving and Christmas or on a seasonal basis and may result in some structural variation. In such a scenario, an XPath that detects price in the web page at the time of thanksgiving may not be able to detect the price in the web page at the time of Christmas.

In light of foregoing discussion there is a need for a technique for web information extraction that overcomes the above-mentioned issues.

### SUMMARY

Embodiments of the present disclosure described herein provide a method, system, and article of manufacture for generating robust XPaths for web information extraction.

An example of a method includes generating an attributed extensible markup language path (XPath) for an annotated entity in a web page. The method further includes determining a first node that satisfy the attributed XPath in the web page and is annotated. The method also includes identifying an attribute property that satisfies predefined criteria in the web page while traversing from the first node to a root node, the attribute property comprising an attribute value and an attribute name. Moreover, the method includes populating the attributed XPath with the attribute property that satisfies predefined criteria. The method also includes filtering the attributed XPath to generate a robust XPath, and extracting content from multiple web pages based on the robust XPath.

An example of an article of manufacture includes a machine readable medium. The machine-readable medium carries instructions operable to cause a programmable processor to perform generating an attributed extensible markup language path (XPath) for an annotated entity in a web page, to determine a first node that satisfy the attributed XPath in the web page and is annotated, to identify an attribute property that satisfies predefined criteria in the web page while traversing from the first node to a root node, the attribute property including an attribute value and an attribute name, to populate the attributed XPath with the attribute property that satisfies predefined criteria, to filter the attributed XPath to generate a robust XPath, and to extract content from multiple web pages based on the robust XPath.

An example of a system includes a communication interface in electronic communication with one or more remotely located web servers including multiple web pages. The system also includes a memory that stores instructions. Further, the system includes a processor responsive to the instructions to generate an attributed extensible markup language path (XPath) for an annotated entity in a web page, to determine a first node that satisfy the attributed XPath in the web page and is annotated, to identify an attribute property that satisfies predefined criteria in the web page while traversing from the first node to a root node, the attribute property including an attribute value and an attribute name, to populate the attributed XPath with the attribute property that satisfies predefined criteria, to filter the attributed XPath to generate a robust XPath, and to extract content from multiple web pages based on the robust XPath.

### BRIEF DESCRIPTION OF THE FIGURES

FIG. 1 is a block diagram of an environment, in accordance with which various embodiments can be implemented;

FIG. 2 is a flowchart illustrating a method for generating robust XPaths for web information extraction;

FIG. 3 is a block diagram of a server, in accordance with one embodiment; and

FIG. 4 is an exemplary illustration of generation of a robust XPath for an attribute property from a tree structure of a web page.

### DETAILED DESCRIPTION OF THE EMBODIMENTS

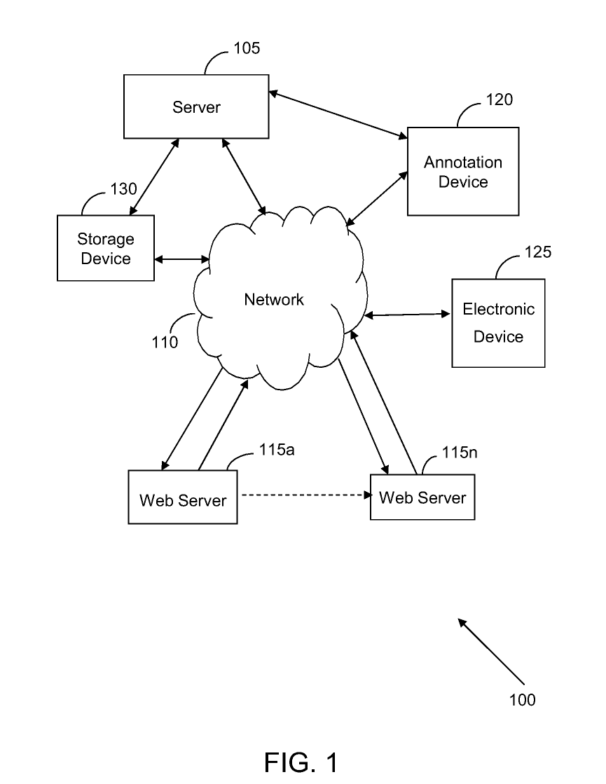

FIG. 1 is a block diagram of an environment 100, in accordance with which various embodiments can be implemented. The environment 100 includes a server 105 connected to a network 110. The server 105 is in electronic communication with one or more web servers, for example a web server 115a and a web server 115n. The web servers can be located remotely with respect to the server 105. Each web server can host one or more websites on the network 110. Each website can have multiple web pages. Examples of the network 110 include, but are not limited to, a Local Area Network (LAN), a Wireless Local Area Network (WLAN), a Wide Area Network (WAN), internet, and a Small Area Network (SAN).

The server 105 is also connected to an annotation device 120 and an electronic device 125 of a user directly or via the network 110. The annotation device 120 and the electronic device 125 can be remotely located with respect to the server 105. Examples of the annotation device 120 include, but are not limited to, computers, laptops, mobile devices, hand held devices, telecommunication devices and personal digital assistants (PDAs). Examples of the electronic device 125 include, but are not limited to, computers, laptops, mobile devices, hand held devices, telecommunication devices and personal digital assistants (PDAs). The annotation device 120 is used for annotating an entity on a web page. For example, a label “LCD TV 32 inch” on the web page can be annotated as TITLE and can be referred as an annotated entity. The annotation of the nodes can be automated or performed manually by an editor. The annotated nodes can then be stored and accessed by the server 105.

A web page can be represented in form of a tree structure having several nodes. A node can have one or more attribute properties, for example a hypertext markup language attribute property, for example “class=price”. Each attribute property includes an attribute name and an attribute value. Each node can be uniquely identified in the tree structure and position of each node is also defined in the tree structure. For example, a node can have the attribute property “class=price”. The attribute property includes the attribute name “class” and the attribute value “price”.

In some embodiments, the server 105 can perform functions of the annotation device 120.

The server 105 is also connected to a storage device 130 directly or via the network 110 to store information.

The server 105 identifies multiple web pages that are homogenous, for example web pages having similar tree structure. The multiple web pages correspond to one site, for example shopping.yahoo.com. The server 105 processes the multiple web pages and for each attribute property counts number of web pages in which the attribute property appears. If the attribute property exists in a predefined number of pages then the server 105 identifies the attribute property as static across the multiple web pages. The predefined number can correspond to a percentage of total number of the multiple web pages and can be determined as 80%. In some embodiments, the predefined number can be determined based on entropy of the attribute properties. The storage device 130 stores information regarding an attribute property being static or not. The server 105 can process the multiple web pages periodically or in response to detection of any change to the tree structure of a web page in the multiple web pages.

The server 105 also generates an attributed extensible markup language path (XPath) for each annotated entity in each annotated web page of a plurality of web pages. The plurality of web pages can be a subset of the multiple web pages. The annotation can be performed using the annotation device 120. Any two web pages having a similar annotated entity may or may not have a similar attributed XPath. The attributed XPath can be obtained from an XPath by removing position information and attribute value from the XPath. An exemplary XPath is:

/html/body/table[2][@width=20]/tr[1][@class=price][@color=red]/td[1][@id=2].

An exemplary attributed XPath generated from the XPath is:

/html/body/table[@width]/tr[@class][@color]/td[@id].

The XPath includes position information such as “[2]” and “[1]” which is removed to generate the attributed XPath. Further, the attribute values “20”, “price”, “red”, and “2” are also removed.

The server 105 determines a node that satisfies the attributed XPath and is annotated in the web page. The server 105 also identifies attribute properties that satisfy predefined criteria while traversing from the node to a root node. The server 105 then populates the attributed XPath with the attribute properties, filters the attributed XPath to generate a robust XPath, and extracts content from the multiple web pages based on the robust XPath. The server 105 also processes the content and provides the content to the electronic device 125 of the user.

In some embodiments, the server 105 process the content in response to an input received from the electronic device 125 of the user. The input can include, for example a search query.

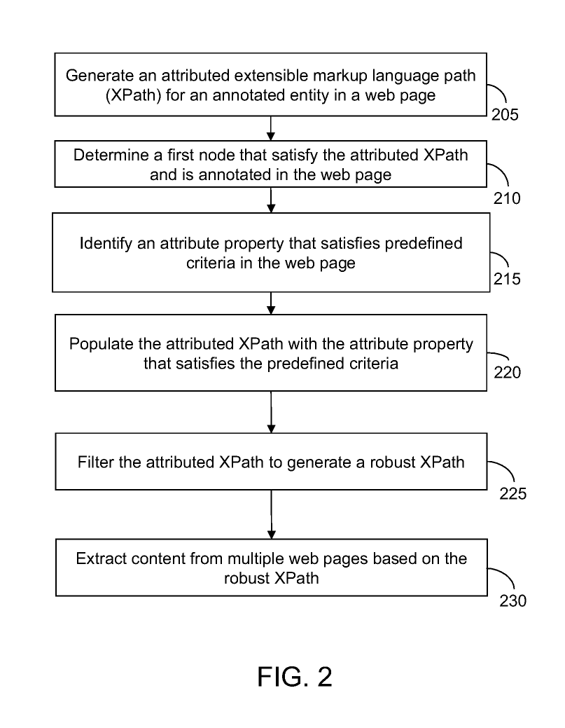

FIG. 2 is a flowchart illustrating a method for generating robust XPaths for web information extraction.

In various embodiments, a web page can be a hyper text markup language (HTML) document or an extensible markup language (XML) document. The web page can be represented by a tree structure including one or more nodes. For example, the tree structure can be a data object model (DOM) structure of the web page. A node represents a tag with one or more attribute properties. An attribute property includes an attribute name and an attribute value. The multiple web pages can be of one website.

A plurality of web pages from the multiple web pages are annotated. Entities on the web pages are annotated.

At step 205, an attributed extensible markup language path (XPath) is generated for an annotated entity in a web page. The annotated entity can be present in more than one web page.

The annotated entity corresponds to a node in the web page. The node can be represented as an XPath in the web page. An Xpath includes a plurality of tags. Each tag can have one or more attribute name-value pairs, and a position information corresponding to the node. The generation of an attributed XPath corresponding to the annotated entity includes removing attribute values and position information associated from the XPath. An exemplary XPath is:

/html/body/table[2][@width=20]/tr[1][@class=price][@color=red]/td[1][@id=2].

An exemplary attributed XPath generated from the XPath is:

/html/body/table[@width]/tr[@class][@color]/td[@id].

In some embodiments, attributed XPaths can be generated for various web pages in which the annotated entity is present. The attributed XPaths for any two web pages having the annotated entity can be similar or different. In case the attributed XPaths are similar then any one is retained else both are considered.

At step 210, a first node that satisfies the attributed XPath and is annotated is determined. The first node is a node corresponding to the annotated entity. Other nodes, for example a second node that satisfy the attributed XPath are also determined. The other nodes are not annotated.

At step 215, an attribute property that satisfies predefined criteria is identified while traversing from the first node to a root node. Attribute properties of various nodes that are encountered while traversing from the first node to the root node are collected and can be marked as positive. The attribute properties marked as positive are filtered to yield the attribute properties that are positive and static across the plurality of web pages. If an attribute property exists in a predefined number of pages then the attribute property is referred to as static. In some embodiments, the traversing is also performed for other nodes identified at step 210. The attribute properties of various nodes that are encountered while traversing from the second node to the root node are collected and marked as negative. The attribute properties that are positive and static across the plurality of web pages are further filtered to yield the attribute property that is static, positive and not present in a list including the attribute properties marked as negative. The attribute property that is static, positive, and not present in a list including the attribute properties marked as negative can be referred to as the attribute property that satisfies the predefined criteria.

In some embodiments, step 205 is performed for the plurality of web pages and for each annotated entity in the plurality of web pages. Step 210 to step 215 is performed for each web page in the plurality of web pages.

At step 220, the attributed XPath is populated with the attribute property. The attributed XPath has an attribute name similar to that of the attribute property. The attributed XPath is analyzed tag by tag starting from an end of the attributed XPath. The tag that includes the attribute name similar to that of the attribute property is identified and an attribute value for that attribute name is inserted in the attributed XPath from the attribute property. For example, if the attribute name “class” is defined in the attributed XPath and the attribute property “class=price” is identified as the attribute property that satisfies the predefined criteria then the attributed XPath is populated with the attribute value “price” corresponding to the attribute name “class”. An exemplary attributed XPath and an exemplary populated Xpath are illustrated below:

Attributed XPath: /html/body/table[@width]/tr[@class][@color]/td[@id].
Populated XPath: /html/body/table[@width]/tr[@class=price][@color]/td[@id].

At step 225, the attributed XPath is filtered to generate a robust XPath. The filtering includes removing tags that precede the tag populated with the attribute property that satisfies the predefined criteria.

An exemplary populated XPath is:

/html/body/table[@width]/tr[@class=price][@color]/td[@id].

An exemplary robust XPath is:

//tr[@class=price]/td[@id]

The robust XPath is associated with the annotated entity and stored.

In some embodiments, step 220 and step 225 are repeated for each annotated entity. Robust XPaths are generated and stored. The robust XPaths are specific for the website including the multiple web pages and are used to create a wrapper for the website. Different wrappers can be created for different websites.

In some embodiments, at step 230, contents from multiple web pages are extracted based on the wrapper including the robust XPath. The extracted content can be provided to a user. For example, the robust XPath for attribute property “class=price” can be used to extract the content corresponding to price of products mentioned on various web pages of the website.

The content extraction includes further processing, for example filtering. The robust XPath can be passed through a filtering framework to make the robust XPath adaptive to variations in characteristics of the entities. The robust XPaths can also be used in conjunction with filters in a filtering framework to extract entities from the multiple pages that are structurally similar. The filtering can be performed, for example using the technique described in U.S. patent application Ser. No. 11/938,736 entitled “EXTRACTING INFORMATION BASED ON DOCUMENT STRUCTURE AND CHARACTERISTICS OF ATTRIBUTES” filed on Nov. 12, 2007 and assigned to Yahoo! Inc., which is incorporated herein by reference in its entirety.

In some embodiments, an input associated with the entity can be received from a user. The content can be extracted in response to the input and provided to the user. For example, if an input associated with the entity “price” is received from the user, then the content is extracted using the robust XPath for the entity “price”. Usage of the robust XPath helps in extracting the content that matches the desired entity but is slightly different, for example due to missing values or tags.

An exemplary algorithm for performing the method described in FIG. 2 is as follows:
1. Input “N” web pages.
   1.1. For each input web page “p” in “N”
      1.1.1 Traverse all XPaths corresponding to nodes present in “p” and collect attribute properties appearing in respective XPaths and keep binary count of the attribute properties.
      1.1.2 Update count of the attribute properties present in “p”.
      1.2. Iterate 1.1.1 over “N” web pages and if the count of one or more attribute properties is greater than a predefined number of the “N” web pages, then identify the one or more attribute properties as static and store the one or more attribute properties.
2. Annotate one or more entities in a subset including “K” web pages of the “N” web pages using manual or automated labeling methods.
3. Collect a set “X” of unique attributed XPaths from the “K” annotated pages for each annotated entity “a”.
4. For each attributed XPath “xi” in “X”, identify corresponding web pages in “K” annotated pages where “xi” belongs.
   4.1 For each page “p” in “K” annotated pages where “xi” belongs
      4.1.1. Determine set of nodes “C” that satisfy attributed XPath “xi”.
      4.1.2. For each node “ci” in “C” set of nodes
         4.1.2.1. Collect attribute properties of xi from ci to root and mark the attribute properties as positive if the ci is annotated or negative if the ci is not annotated.
   4.2. Take intersection of positive and negative attribute properties and remove common properties from positive set. Also, remove those attribute properties from positive set which are not static.
   4.3. Look xi tag by tag level and check if the attribute property names are present in the positive set. If yes, insert the attribute property values also in the attributed xpath xi and generate populated xpath xi′.
   4.4. Traverse xi′ from right to left and at any tag if an attribute property with attribute value appears, replace the remaining tags towards left till the next attribute property that is static by // to generate a robust XPath x′.

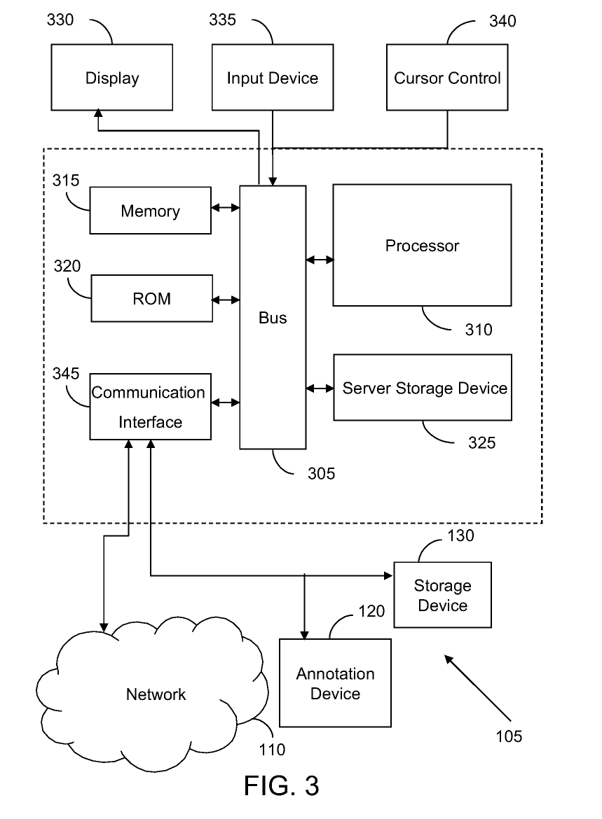

FIG. 3 is a block diagram of a server 105, in accordance with one embodiment. The server 105 includes a bus 305 for communicating information, and a processor 310 coupled with the bus 305 for processing information. The server 105 also includes a memory 315, for example a random access memory (RAM) coupled to the bus 305 for storing instructions to be executed by the processor 310. The memory 315 can be used for storing temporary information required by the processor 310. The server 105 may further include a read only memory (ROM) 320 coupled to the bus 305 for storing static information and instructions for the processor 310. A server storage device 325, for example a magnetic disk, hard disk or optical disk, can be provided and coupled to the bus 305 for storing information and instructions.

The server 105 can be coupled via the bus 305 to a display 330, for example a cathode ray tube (CRT) or a liquid crystal display (LCD), for displaying information. An input device 335, for example a keyboard, is coupled to the bus 305 for communicating information and command selections to the processor 310. In some embodiments, cursor control 340, for example a mouse, a trackball, a joystick, or cursor direction keys for command selections to the processor 310 and for controlling cursor movement on the display 330 can also be present.

In one embodiment, the steps of the present disclosure are performed by the server 105 in response to the processor 310 executing instructions included in the memory 315. The instructions can be read into the memory 315 from a machine-readable medium, for example the server storage device 325. In alternative embodiments, hard-wired circuitry can be used in place of or in combination with software instructions to implement various embodiments.

The term machine-readable medium can be defined as a medium providing content to a machine to enable the machine to perform a specific function. The machine-readable medium can be a storage media. Storage media can include non-volatile media and volatile media. The server storage device 325 can be non-volatile media. The memory 315 can be a volatile medium. All such media must be tangible to enable the instructions carried by the media to be detected by a physical mechanism that reads the instructions into the machine.

Examples of the machine readable medium include, but are not limited to, a floppy disk, a flexible disk, hard disk, magnetic tape, a CD-ROM, optical disk, punchcards, papertape, a RAM, a PROM, EPROM, and a FLASH-EPROM.

The machine readable medium can also include online links, download links, and installation links providing the instructions to be executed by the processor 310.

The server 105 also includes a communication interface 345 coupled to the bus 305 for enabling communication. Examples of the communication interface 345 include, but are not limited to, an integrated services digital network (ISDN) card, a modem, a local area network (LAN) card, an infrared port, a Bluetooth port, a zigbee port, and a wireless port.

The server 105 is also connected to a storage device 130 that stores attribute properties that are static across the plurality of web pages and the robust XPaths.

In some embodiments, the processor 310 can include one or more processing devices for performing one or more functions of the processor 310. The processing devices are hardware circuitry performing specified functions.

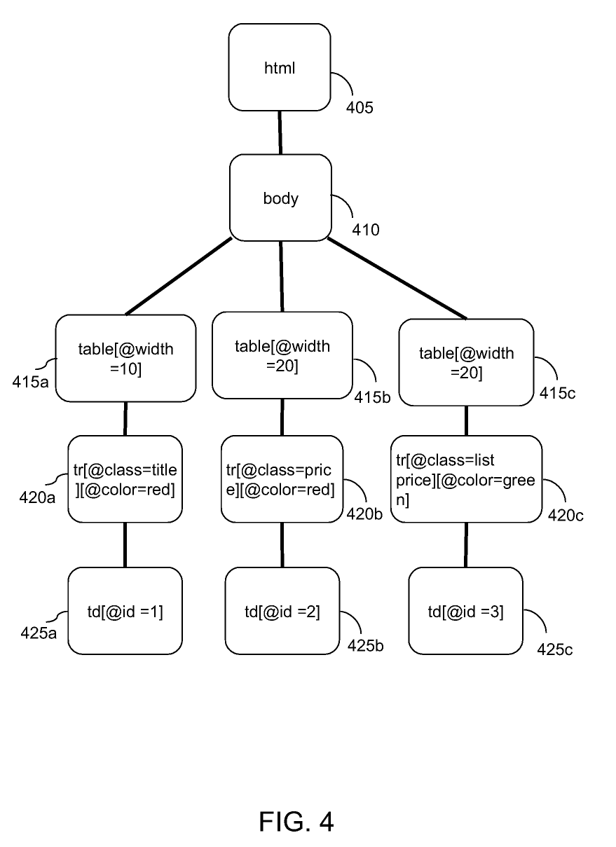

FIG. 4 is an exemplary illustration of generation of a robust XPath for an annotated entity from a tree structure of a web page.

Attribute properties “class=price” and “color=red” are determined to be present in 80% of total web pages of a website and is identified as static across multiple web pages of the website. A node 425b corresponds to an annotated entity and hence the node 425b is considered to be annotated. An XPath corresponding to the 425b is

/html/body/table[2][@width=20]/tr[1][@class=price][@color=red]/td[1][@id=2].

An attributed XPath corresponding to the node 425b is then generated as:

/html/body/table[@width]/tr[@class][@color]/td[@id].

The attributed XPath is applied on the web page. A node 425a, a node 425c and the node 425b satisfying the attributed XPath are then determined. The node 425a and the node 425c are not annotated. A path from the node 425b to a root node 405 is then traversed and attribute properties corresponding to the node 425b, a node 420b and a node 415b are marked as positive and identified as annotated. Similarly, traversal is made from the node 425a to the root node 405 and from the node 425c to the root node 405, and attribute properties corresponding to a node 415a, a node 420a, the node 425a, a node 415c, a node 420c and the node 425c are marked as negative and identified as not annotated. The attribute properties “class=price” and “color=red” are identified as positive and static across the multiple web pages. A check is further performed to remove the attribute property that is marked as negative. The attribute property “color=red” is filtered out and the attribute property “class=price” is identified as the attribute property that satisfies the predefined criteria.

The attribute XPath is then populated with “class=price” as follows:

/html/body/table[@width]/tr[@class=price][@color]/td[@id].

A robust XPath is then generated as follows:

//tr[@class=price][@color]/td[@id].

The robust XPath helps in extracting content that could otherwise have been discarded if an XPath was used for extraction. For example, the XPath /html/body/table[2][@width=20]/tr[1][@class=price][@color=red]/td[1][@id=2] may not extract the content which has missing attribute value for the attribute property “width=” but has rest all tags similar to the XPath. The robust XPath can extract such content as the robust XPath does not have limitation of the attribute value for width.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method comprising:
electronically generating an attributed extensible markup language path (XPath) for an annotated entity in a web page;
electronically determining a first node that satisfy the attributed XPath in the web page and is annotated;
electronically identifying an attribute property that satisfies predefined criteria in the web page while traversing from the first node to a root node, the attribute property comprising an attribute value and an attribute name;
electronically populating the attributed XPath with the attribute property that satisfies predefined criteria;
electronically filtering the attributed XPath to generate a robust XPath; and
electronically extracting content from multiple web pages based on the robust XPath.

2. The method as claimed in claim 1, wherein electronically generating the attributed XPath comprises:
removing at least one of attribute value and position information from an XPath of the annotated entity.

3. The method as claimed in claim 1, wherein electronically identifying the attribute property that satisfies predefined criteria comprises:
identifying the attribute property that corresponds to an annotated node; and
identifying the attribute property that is static across the multiple web pages.

4. The method as claimed in claim 3, wherein electronically identifying the attribute property that satisfies predefined criteria further comprises:
determining a second node that satisfy the attributed XPath in the web page and is not annotated; and
identifying the attribute property that is different from attributed properties corresponding to nodes encountered while traversing from the second node to the root node.

5. The method as claimed in claim 1, wherein electronically filtering the attributed XPath comprises:
removing tags that precede a tag comprising the attribute property that satisfies predefined criteria in the attributed XPath.

6. The method as claimed in claim 1 and further comprising:
processing the content; and
providing content to an electronic device of a user.

7. The method as claimed in claim 1 and further comprising:
associating the robust XPath with the annotated entity; and
storing the robust XPath.

8. An article of manufacture comprising:
a machine readable medium; and
instructions carried by the machine-readable medium and operable to cause a programmable processor to perform:
generating an attributed extensible markup language path (XPath) for an annotated entity in a web page;
determining a first node that satisfy the attributed XPath in the web page and is annotated;
identifying an attribute property that satisfies predefined criteria in the web page while traversing from the first node to a root node, the attribute property comprising an attribute value and an attribute name;
populating the attributed XPath with the attribute property that satisfies predefined criteria;
filtering the attributed XPath to generate a robust XPath; and
extracting content from multiple web pages based on the robust XPath.

9. The article of manufacture of claim 8, wherein generating the attributed XPath comprises:
removing at least one of attribute value and position information from an XPath of the annotated entity.

10. The article of manufacture of claim 8, wherein identifying the attribute property that satisfies predefined criteria comprises:
identifying the attribute property that corresponds to an annotated node; and
identifying the attribute property that is static across multiple web pages.

11. The article of manufacture of claim 10, wherein identifying the attribute property that satisfies predefined criteria further comprises:
determining a second node that satisfy the attributed XPath in the web page and is not annotated; and
identifying the attribute property that is different from attributed properties corresponding to nodes encountered while traversing from the second node to the root node.

12. The article of manufacture of claim 8, wherein filtering the attributed XPath comprises:
removing tags that precede a tag comprising the attribute property that satisfies predefined criteria in the attributed XPath.

13. The article of manufacture as claimed in claim 8 and further comprising instructions operable to cause the programmable processor to perform:
processing the content; and
providing content to an electronic device of a user.

14. The article of manufacture as claimed in claim 8 and further comprising instructions operable to cause the programmable processor to perform:
associating the robust XPath with the annotated entity; and
storing the robust XPath.

15. A system comprising:
a communication interface in electronic communication with one or more web servers comprising multiple web pages;
a memory that stores instructions; and
a processor responsive to the instructions to
generate an attributed extensible markup language path (XPath) for an annotated entity in a web page;
determine a first node that satisfy the attributed XPath in the web page and is annotated;
identify an attribute property that satisfies predefined criteria in the web page while traversing from the first node to a root node, the attribute property comprising an attribute value and an attribute name;
populate the attributed XPath with the attribute property that satisfies predefined criteria;
filter the attributed XPath to generate a robust XPath; and
extract content from multiple web pages based on the robust XPath.

16. The system of claim 15, wherein the processor is further responsive to the instructions to:
process the content; and
provide content to an electronic device of a user.

17. The system of claim 15 further comprising:
a storage device that stores attribute properties that are static across the multiple web pages.

18. The system of claim 17, wherein the storage device further stores the robust XPath.
